(19) United States
(12) Patent Application Publication
(10) Pub. No.: US 2026/0103152 A1
(43) Pub. Date: Apr. 16, 2026

(54) WIRE HARNESS FOR VEHICLE

(71) Applicant: Ford Global Technologies, LLC, Dearborn, MI (US)

(72) Inventors: Andrei Negrus, Prospect, KY (US); Derrick Miller, Ypsilanti, MI (US); Jon Arthur Zimmerman, Ferndale, MI (US); Kurt Michael Lundeen, Novi, MI (US); Zachary James Kadykowski, Chelsea, MI (US); John Randolf Vincent, Livonia, MI (US)

(73) Assignee: Ford Global Technologies, LLC, Dearborn, MI (US)

(21) Appl. No.: 18/917,415

(22) Filed: Oct. 16, 2024

(51) Int. Cl. B60R 16/02

(52) U.S. Cl. CPC B60R 16/0215

(57) ABSTRACT

A wire harness for a vehicle includes a body and a retention structure. The body includes a main section and a connecting section. The connecting section is movable between a stowed position in which the connecting section is fixed relative to the main section and a deployed position in which the connecting section is movable relative to the main section. The retention structure includes a retention socket coupled to one of the main section and the connecting section and a first retention feature coupled to the other of the main section and the connecting section. The first retention feature is received in the retention socket when the connecting section is in the stowed position and is removed from the retention socket when the connecting section is in the deployed position. The body includes a second retention feature adapted to support one electrical connector of electrical components.

### FIELD

The present disclosure relates to a wire harness for a vehicle.

### BACKGROUND

The statements in this section merely provide background information related to the present disclosure and may not constitute prior art.

Industrial robots have been used for a variety of manufacturing operations, including by way of example, welding and moving parts from one location to another such as retrieving parts from a storage location and moving them to an assembly station. Automating the moving of some vehicle parts such as wire harnesses, for example, may be challenging because of the lack of proper handling of the part and mechanical repeatability.

These issues related to automating the handling of components, among other issues related to processing the components, are addressed by the present disclosure.

### SUMMARY

This section provides a general summary of the disclosure and is not a comprehensive disclosure of its full scope or all of its features.

In one form, the present disclosure provides a wire harness for a vehicle that includes a body and a retention structure. The body is configured to house electrical components of the vehicle and includes a main section and a first connecting section. The first connecting section is movable between a stowed position in which the first connecting section is fixed relative to the main section and a deployed position in which the first connecting section is movable relative to the main section. The retention structure includes a first retention socket coupled to one of the main section and the first connecting section and a first retention feature coupled to the other of the main section and the first connecting section. The first retention feature is received in the first retention socket when the first connecting section is in the stowed position to fix the first connecting section relative to the main section and is removed from the first retention socket when the first connecting section is in the deployed position such that the first connecting section is movable relative to the main section. The body includes a second retention feature adapted to support one electrical connector of the electrical components.

In variations of the wire harness of the above paragraph, which can be implemented individually or in any combination: the main section and the first connecting section are made of a rigid material; when the first connecting section is in the stowed position, the first connecting section abuts against the main section, and when the first connecting section is in the deployed position, the first connecting section is spaced apart from the main section; the main section has a length that is greater than a length of the first connecting section; when the first connecting section is in the stowed position, the first connecting section extends in the same direction as the main section and is stacked onto the main section; the wire harness further includes a second connecting section movable between a stowed position in which the second connecting section is fixed relative to the main section and a deployed position in which the second connecting section is movable relative to the main section; the first connecting section and the second connecting section are located at opposing ends of the main section; the first connecting section and the second connecting section are located at the same end of the main section; the first connecting section and the second connecting section are movable between the stowed positions and the deployed positions independently of each other; the wire harness further includes the electrical components, a first end of one electrical component of the electrical components is secured to the main section and a second opposing end of the one electrical component secured to the first connecting section; the wire harness further includes a first collar surrounding and coupled to the first connecting section, the first collar including the first retention feature of the retention structure and the second retention feature, the electrical connector is removably coupled to the second retention feature; the wire harness further includes a second collar surrounding and coupled to the main section, the second collar including an attachment feature configured to couple the body to the vehicle; and the first connecting section is located entirely external to a cavity of the main section when in the stowed position.

In another form, the present disclosure provides a wire harness for a vehicle that includes a body and a plurality of retention structures. The body is configured to house electrical components of the vehicle and includes a main section and a plurality of connecting sections. Each connecting section is movable between a stowed position in which the connecting section is fixed relative to the main section and a deployed position in which the connecting section is movable relative to the main section. Each retention structure includes a first retention socket coupled to one of the main section and a respective connecting section and a first retention feature coupled to the other of the main section and the respective connecting section. The first retention feature is received in the first retention socket when the respective connecting section is in the stowed position to fix the respective connecting section relative to the main section and is removed from the first retention socket when the respective connecting section is in the deployed position such that the respective connecting section is movable relative to the main section. The body includes a second retention feature adapted to support at least one electrical connector of the electrical components.

In variations of the wire harness of the above paragraph, which can be implemented individually or in any combination: the main section and the plurality of connecting sections are made of a rigid material; when the respective connecting section is in the stowed position, the respective connecting section abuts against the main section, and when the respective connecting section is in the deployed position, the respective connecting section is spaced apart from the main section; the main section has a length that is greater than a length of the respective connecting section; when the respective connecting section is in the stowed position, the respective connecting section extends in the same direction as the main section and is stacked onto the main section; and the plurality of connecting sections are movable between the stowed positions and the deployed positions independently of each other.

In yet another form, the present disclosure provides a wire harness for a vehicle that includes a plurality of electrical components, a body and a plurality of retention structures. The body houses the plurality of electrical components and includes a main section and a plurality of connecting sections. Each connecting section is movable between a stowed position in which the connecting section is fixed relative to the main section and a deployed position in which the connecting section is movable relative to the main section. Each retention structure includes a first retention socket coupled to one of the main section and a respective connecting section and a retention feature coupled to the other of the main section and the respective connecting section. The retention feature is received in the first retention socket when the respective connecting section is in the stowed position to fix the respective connecting section relative to the main section and is removed from the first retention socket when the respective connecting section is in the deployed position such that the respective connecting section is movable relative to the main section. A first end of one electrical component of the plurality of electrical components is coupled to the main section and a second opposing end of the one electrical component is coupled to a respective connecting section of the plurality of the connecting sections.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a perspective view of a system for handling components of a vehicle according to the principles of the present disclosure with a wire harness component of the components being disposed on a work surface;

FIG. 2 is a perspective view of a wire harness component shown in FIG. 1 secured to a fixture;

FIGS. 3A and 3B are perspective views of one robot detaching one section of the wire harness component of FIG. 1 from another section and moving the section to the fixture;

FIG. 4 is a perspective view of an electrical connector of the wire harness component of FIG. 1 being connected to a vehicle module component of the vehicle;

FIG. 5 is a perspective view of the electrical connector of the wire harness component of FIG. 1 connected to the vehicle module component of the vehicle;

FIG. 6A is a perspective view of one collar of a plurality of collars of the system of FIG. 1;

FIG. 6B is a top view of the collar shown in FIG. 6A;

FIG. 7A is a perspective view of another collar of a plurality of collars of the system of FIG. 1;

FIG. 7B is a perspective view of one electrical connector of a plurality of electrical connectors of the system of FIG. 1;

FIGS. 8A and 8B are schematic views of another wire harness component in the stowed and deployed positions;

FIGS. 9A and 9B are schematic views of yet another wire harness component in the stowed and deployed positions; and

FIGS. 10A and 10B are schematic views of yet another wire harness component in the stowed and deployed positions.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

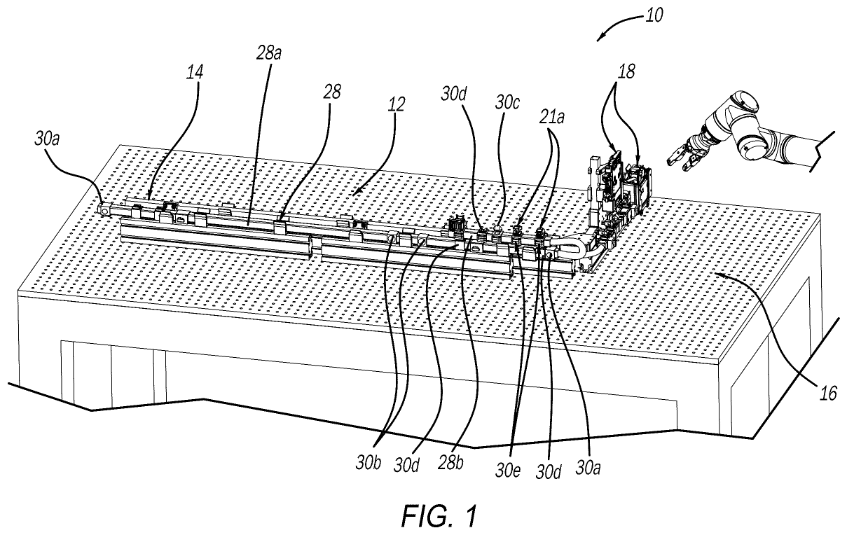

With reference to FIG. 1, a system 10 for handling one or more vehicle components 12 is illustrated. The handling of the vehicle components 12 may include retrieving the vehicle components 12 from a part support (e.g., a dunnage rack), placing the vehicle components 12 onto a work surface 16, manipulating parts of the vehicle components 12 on the work surface 16, and/or installing the vehicle components 12 into a machine (e.g., a vehicle). The system 10 allows for the handling of the vehicle components 12 with little to no human intervention. In this way, the handling of the vehicle components 12 may be automated to increase productivity, reduce cycle time, and reduce variation and error, for example. In the example illustrated, the vehicle components 12 include as wire harnesses. That is, wire harnesses tend to include flexible, complex, and highly variable from one part to the next, so that installation of the wire harness into the machine may be challenging to automate. The system 10 of the present disclosure provides for the adaptation of vehicle components 12 such as wire harnesses to better support automation. It should be understood that the vehicle components 12 may be other components of a vehicle other than wire harnesses.

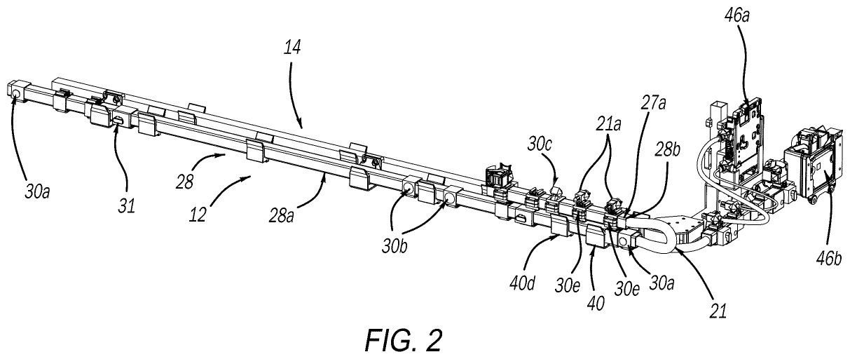

Each vehicle component 12 may be moved to a fixture 14 from the part support (not shown). The fixture 14 allows for the vehicle component 12 to be further process. One example of the fixture 14 is disclosed in U.S. patent application Ser. No. ______/000,000, and titled “METHOD AND SYSTEM FOR INSTALLING WIRING HARNESS INTO VEHICLE” which is commonly owned with the present application and the contents of which are incorporated herein by reference in its entirety. With reference to FIG. 2, each vehicle component 12 includes a body or housing 28 and a plurality of collars 30a, 30b, 30c, 30d, 31. The body 28 may be made of a rigid material (e.g., metal or plastic) and may house electrical components 21 (e.g., flexible wires). In the example illustrated, the body 28 is hollow and has a square shape. In some forms, the body 28 may have a circular shape, rectangular shape, or any other suitable shape that may be house electrical components 21.

In the example illustrated, the body 28 includes multiple sections 28a, 28b that are movable relative to each other. For example, the section 28a may be the main section and the section 28b may be a connecting section. The sections 28a, 28b may be coupled to each other (e.g., folding onto each other) as the vehicle component 12 moves from the part support (not shown) to the fixture 14. In this way, moving the vehicle component 12 to the fixture 14 is facilitated. Once the vehicle component 12 is coupled to the fixture 14, the sections 28a, 28b of the vehicle component 12 may be decoupled from each other (e.g., unfolded from each other) using the robot (not shown) and positioned at predetermined positions with respect to each other for further processing. In the example illustrated, the section 28b is folded onto the section 28a at or near a first end 27a of the section 28a. In some forms, the section 28b may be folded onto the section 28a at or near a central portion of the section 28a.

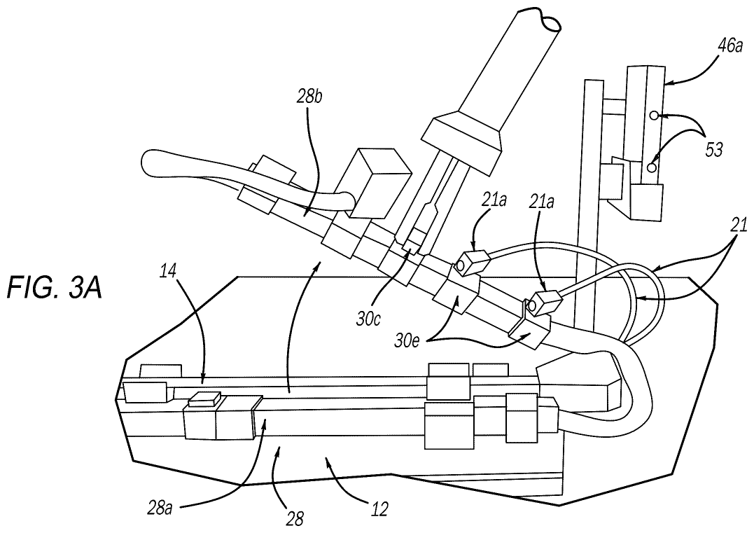

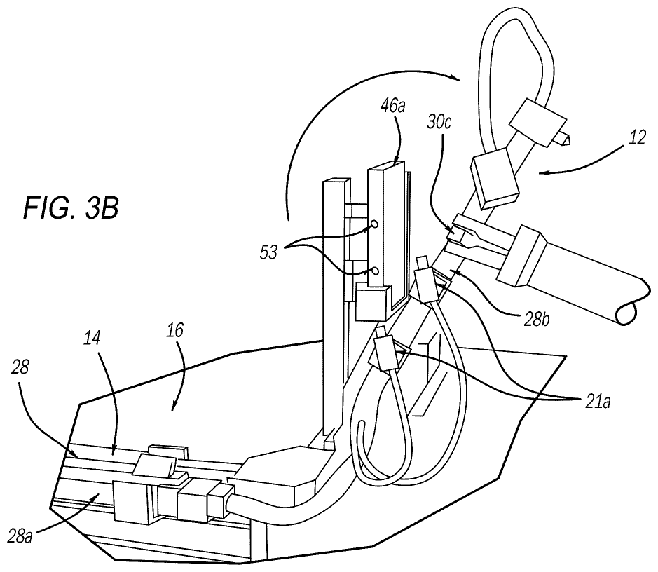

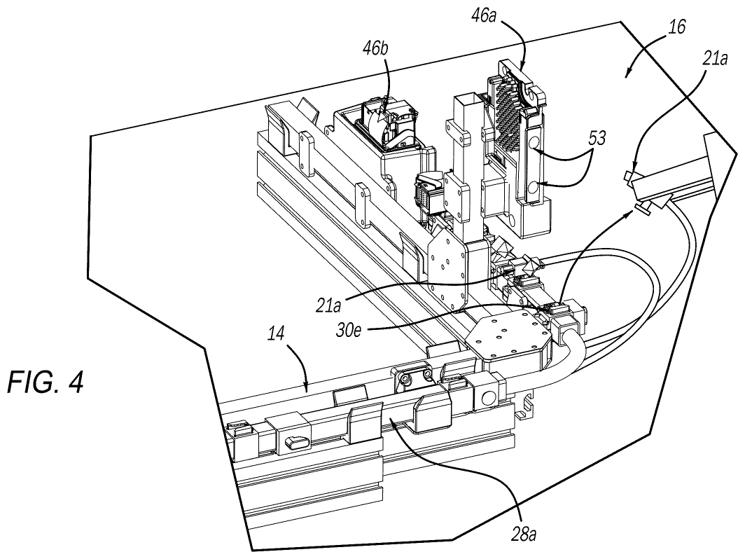

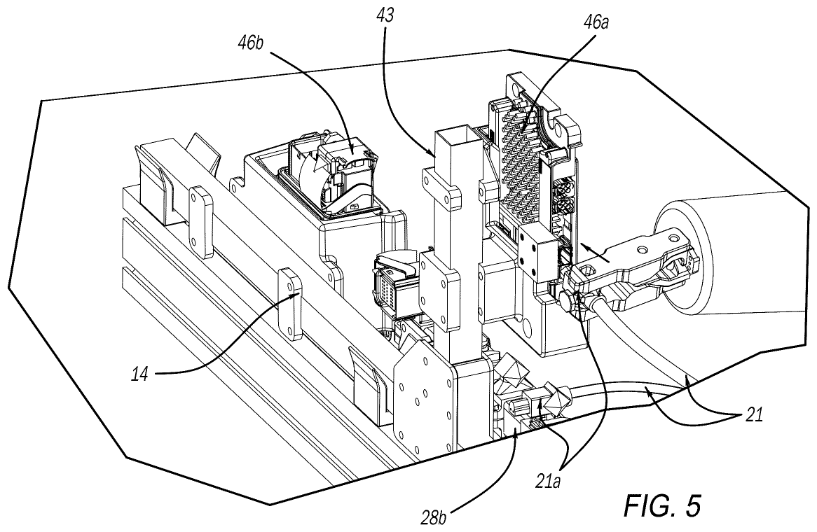

With reference to FIGS. 2, 3A, and 3B, the section 28b of the vehicle component 12 is decoupled or detached from the section 28a and positioned with respect to the section 28a once the vehicle component 12 is coupled to the fixture 14. The section 28b may be positioned at a perpendicular angel, obtuse angle or acute angle, for example, with respect to the section 28a. Stated differently, the connecting section 28b is movable between a stowed position (FIG. 2) in which the connecting section 28b is fixed relative to the main section 28a and a deployed position (FIGS. 3A and 3B) in which the connecting section 28b is movable relative to the main section 28a. The section 28b is located entirely external to the section 28a in the stowed and deployed positions. In this way, electrical components 21 within the body 28 are not impaired by the retention structure.

In the example illustrated, the sections 28a, 28b may be spaced apart from each other once the section 28b of the vehicle component 12 is coupled to the fixture 14. That is, the section 28b may be moved from the stowed position (the section 28b abuts against the section 28a when in the stowed position) to the deployed position once the vehicle component 12 is moved to the fixture 14 such that the section 28b is spaced apart from the section 28a. In the example illustrated, the section 28a of the vehicle component 12 has a length that is greater than a length of the section 28b of the vehicle component 12. In some forms, the section 28a of the vehicle component 12 may have a length that is equal to or less than a length of the section 28b of the vehicle component 12. It should be understood that the electrical components 21 (e.g., wires) extend through the sections 28a, 28b of the body 28 and may have ends (e.g., electrical connectors 21a) that are secured to the body 28 as will be described in greater detail below. It should also be understood that although the present disclosure discloses the body 28 having two sections 28a, 28b movable relative to each other, the body 28 may include more than two sections movable relative to each other without departing from the scope of the present disclosure.

With reference to FIGS. 1 and 2, the collars 30a may be coupled at opposing ends of the section 28a of the vehicle component 12 and may be configured to attach the vehicle component 12 to the part support (not shown). One example of such collar is disclosed in U.S. patent application Ser. No. ______/000,000, and titled “SYSTEM FOR HANDLING A COMPONENT OF A VEHICLE” which is commonly owned with the present application and the contents of which are incorporated herein by reference in its entirety. The collars 30b may be coupled to the section 28a of the vehicle component 12 between the collars 30a and may be configured to allow a robot (not shown) to grasp the vehicle component 12 for moving from the part support to the fixture 14. One example of such collar is disclosed in U.S. patent application Ser. No. ______/000,000, and titled “SYSTEM FOR HANDLING A COMPONENT OF A VEHICLE” which is commonly owned with the present application and the contents of which are incorporated herein by reference in its entirety.

One or more collars 30c may be coupled to the section 28b of the vehicle component 12 and may be configured to allow a robot (not shown) to grasp the section 28b of the vehicle component 12 and decouple the section 28b from the section 28a. One example of such collar is disclosed in U.S. patent application Ser. No. ______/000,000, and titled “SYSTEM FOR HANDLING ELECTRICAL COMPONENTS OF A VEHICLE” which is commonly owned with the present application and the contents of which are incorporated herein by reference in its entirety.

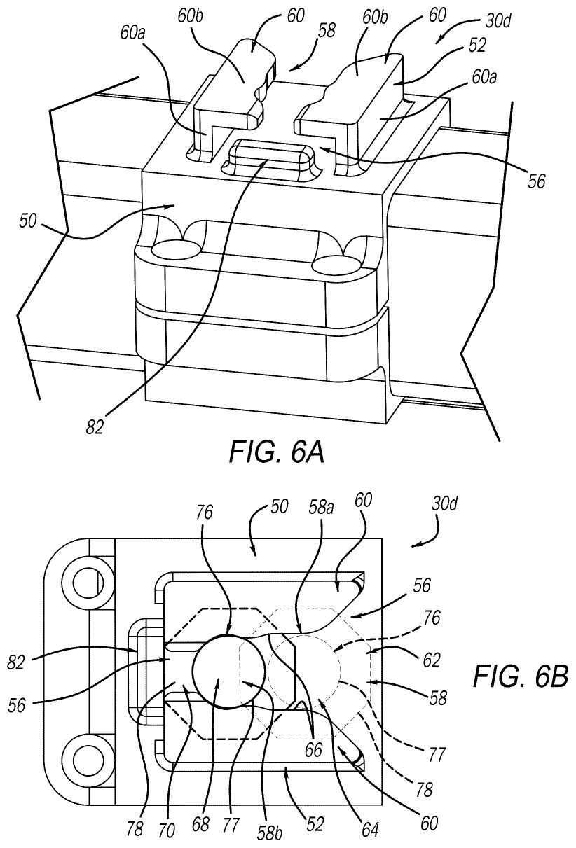

With reference to FIGS. 1, 6A, and 6B, the collars 30d may be coupled to one of the sections 28a, 28b of the body 28 and may be configured to secure the other of the sections 28a, 28b of the body 28 relative to the one of the sections 28a, 28b. Each collar 30d includes a body 50 and at least one retention socket 52. In the example illustrated, the body 50 surrounds the body 28 of the vehicle component 12 and is secured to the body 28 via mechanical fasteners. The body 50 has a shape that corresponds to the shape of the body 28. In the example illustrated, the body 50 has a square shape that corresponds to the square shape of the body 28. The body 50 also has end portions defining apertures. Mechanical fasteners may extend through the apertures of the end portions, thereby securing (e.g., clamping) the body 50 onto the body 28.

The retention socket 52 extends from a respective side of the body 50 and is configured to receive a retention feature 76 of the collar 30e (or retention feature 85b of the electrical connector 21a) as will be described in more detail below. In the example illustrated, a plurality of collars 30d including multiple retention sockets 52 are secured to a second end 27b of the section 28a while a plurality of collars 30d including a single retention socket 52 are secured to the first end 27a of the section 28a. The retention socket 52 defines an internal cavity 56 and an opening 58 in communication with the internal cavity 56. One example of such retention socket is disclosed in U.S. patent application Ser. No. ______/000,000, and titled “SYSTEM FOR HANDLING ELECTRICAL COMPONENTS OF A VEHICLE” which is commonly owned with the present application and the contents of which are incorporated herein by reference in its entirety.

With reference to FIGS. 1, 2, and 7A, the collars 30e may be coupled to the body 28 (e.g., the section 28b of the body 28 or the section 28a of the body 28) of the vehicle component 12 and may be configured to perform multiple functions. For example, the collars 30e may secure electrical connectors 21a of the electrical components 21 to the body 28 and may be configured to secure one of the sections 28a, 28b of the body 28 relative to the other of the sections 28a, 28b of the body 28. Each collar 30e includes a body 72, a retention socket or feature 74, and the retention feature 76. In the example illustrated, the body 72 surrounds the section 28b of the body 28 of the vehicle component 12 and is secured to the section 28b of the body 28 via mechanical fasteners. The body 72 has a shape that corresponds to the shape of the body 28. In the example illustrated, the body 72 has a square shape that corresponds to the square shape of the body 28. The body 72 also has end portions defining apertures. Mechanical fasteners may extend through the apertures of the end portions, thereby securing (e.g., clamping) the body 72 onto the body 28.

The retention socket 74 extends from a side of the body 72 and is configured to receive a retention feature 85b of a respective electrical connector 21a as will be described in more detail below. The structure and function of the retention socket 74 may be similar or identical to the retention socket 52 described above, and therefore, will not be described again in detail.

The retention feature 76 extends from a side of the body 72 that is opposite the side and is configured to be received in the opening 58 of the collar 30d. That is, the retention feature 76 may be movable within the opening 58 of the collar 30d between a first position in which the retention feature 76 is received in the first portion 58a of the opening 58 of the retention socket 52 (shown in FIG. 6B in phantom lines) and a second position in which the retention feature 76 is received in the second portion 58b of the opening 58 of the retention socket 52 (shown in FIG. 6B in solid lines). When the retention feature 76 is in the first position, the retention feature 76 (and the section 28b of the body 28) is allowed to move relative to the section 28a of the body 28, and when the retention feature 76 is in the second position, the retention feature 76 (and the section 28b of the body 28) is inhibited from moving relative to the section 28a of the body 28.

The retention feature 76 includes a neck region 77 and a tab 78. In the example illustrated, the neck region 77 has a generally cylindrical shape and extends between the tab 78 and the side of the body 72. The neck region 77 is also configured to be received in the opening 58 of the retention socket 52 of the collar 30d. That is, when the neck region 77 is received in a first portion 58a of the opening 58, the collar 30e (and the section 28b) is allowed to move relative to the section 28a of the body 28 (shown phantom lines in FIG. 6B). When the neck region 77 is received in a locking region 68 of the opening 58, the collar 30e (and the section 28b of the body 28) is inhibited from moving relative to the section 28a of the body 28 (shown in solid lines in FIG. 6B). When a predetermined force is applied to the retention feature 76, the retention feature 76 pushes on tabs 66, which, in turn, causes a pair of walls 60 to move away from each other. In this way, the neck region 77 of the retention feature 76 may move into the locking region 68 where it is inhibited from moving relative to the collar 30d (and the section 28a of the body 28).

In the example illustrated, the tab 78 is configured to be received in the internal cavity 56 of the retention socket 52 and has a polygonal shape. Stated differently, the tab 78 has an octagonal shape with a plurality of flat sides 79. In this way, the retention feature 76 has multiple insertion orientations into the internal cavity 56 (i.e., the tab 78 can be inserted into the internal cavity 56 every 45 degrees). In some forms, the tab 78 may have a square shape or any other suitable shape that gives the tab 78 multiple insertion orientations into the internal cavity 56. Once the tab 78 is inserted into the internal cavity 56, two flat sides of the tab 78 correspond to two inner sides of the retention socket 52, thereby inhibiting the retention feature 76 from rotating within the retention socket 52. It should be understood that, in some configurations, collars (not shown) may be provided on the body 28 that include one or more retention features 76 without the retention sockets 52. Although the present disclosure shows the retention socket 74 and the retention feature 76 as being separate from the body 28, in some forms, the body 28 may be manufactured (e.g., injection molding or 3D printing) to include the retention socket 74 and the retention feature 76. In this way, the body 28 may be a unitary, monolithic component including the retention socket 74 and the retention feature 76. The retention sockets 52 of the collars 30d, the retention features 76 of the collar 30e, and the retention features 74 of the collars 30e cooperate to form a retention structure 80.

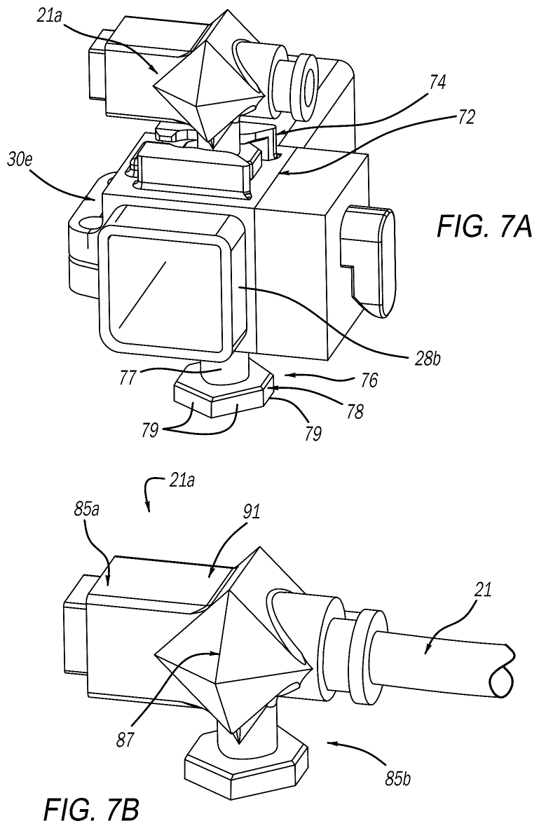

With reference to FIGS. 1, 2, and 7B, the electrical connectors 21a may extend from the electrical components 21 and may be supported by the collars 30d, 30e. The electrical connectors 21a are removably coupled to the collars 30d, 30e (and the body 28) and may be configured to connect to the vehicle modules 18 or other systems (e.g., electrical systems) of the vehicle, thereby transmitting electric power and information to the vehicle modules 18 and systems. The electrical connectors 21a may be removed from the collars 30d, 30e at the work surface 16 and connected to the vehicle modules 18 and systems using the robot (not shown). In some forms, the electrical connectors 21a may be removed from the collars 30d, 30e at the final assembly line and connected to the vehicle modules 18 and systems. Each electrical connector 21a may include a body 85a, the first retention feature 85b and second retention features 87 (only one shown in FIG. 7B). The first retention feature 85b extends from the body 85a and is configured to be removably coupled to the retention socket 74 of the collar 30e. The structure and function of the first retention feature 85b may be similar or identical to the retention feature 76 described above, and therefore, will not be described again in detail. The second retention features 87 extend from opposing sides of the body 85a and are configured to be grasp by the robot such that the robot may move the electrical connector 21a from a respective collar 30d, 30e and connect the electrical connector 21a to a terminal. The structure and function of the second retention features 87 may be similar or identical to retention features 40a, 40b of the collar 30c described above, and therefore, will not be described again in detail. One example of such electrical connector 21a is disclosed in U.S. patent application Ser. No. ______/000,000, and titled “SYSTEM FOR HANDLING ELECTRICAL COMPONENTS OF A VEHICLE” which is commonly owned with the present application and the contents of which are incorporated herein by reference in its entirety.

The collars 31 may be coupled to the sections 28a, 28b of the vehicle component 12 and may be configured to attach the vehicle component 12 to the machine (e.g., vehicle). The collars 31 may include one or more of clips, tabs, fasteners to attach the vehicle component 12 to the machine. One example of such collar is disclosed in U.S. Patent App. No. XX/000,000, and titled “RETENTION ASSEMBLY FOR COUPLING WIRING HARNESS TO VEHICLE HAVING ELECTRICAL GROUND” which is commonly owned with the present application and the contents of which are incorporated herein by reference in its entirety.

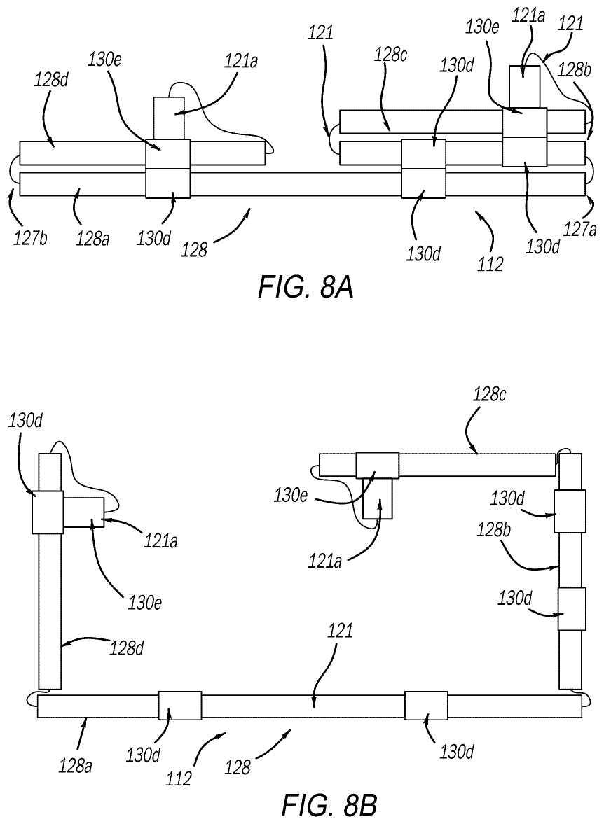

With reference to FIGS. 8A and 8B, another vehicle component 112 is provided. The structure and function of vehicle component 112 is similar or identical to the vehicle component 12 described above, apart from any exception noted below.

The vehicle component 112 includes a body or housing 128, a plurality of collars first collars (not shown), a plurality of second collars 130d, and a plurality of third collars 130e. The body 128 may be made of a rigid material (e.g., metal or plastic) and may house electrical components (e.g., flexible wires). In the example illustrated, the body 128 includes multiple sections 128a, 128b, 128c, 128d that are movable relative to each other. For example, the section 128a may be the main section and the sections 128b, 128c, 128d may be connecting sections. The sections 128a, 128b, 128c, 128d may be coupled to each other (e.g., folding onto each other) as the vehicle component 112 moves from the part support (not shown) to the fixture (not shown). Once the vehicle component 112 is coupled to the fixture, the sections 128a, 128b, 128c, 128d of the vehicle component 112 may be decoupled from each other (e.g., unfolded from each other) using the robot (not shown) and positioned at predetermined positions with respect to each other for further processing. In the example illustrated, the sections 128b, 128c, 128d are folded or stacked onto the section 128a. That is, the sections 128b and 128c are folded onto an upper side of the section 128a at or near a first end 127a of the section 128a and the section 128d is folded onto the upper side at or near a second end 127b of the section 128a.

In the example illustrated, the sections 128b, 128c, 128d of the vehicle component 112 are decoupled or detached from the section 128a and positioned with respect to the section 128a once the vehicle component 112 is coupled to the fixture. As shown in FIG. 8B, the sections 128a, 128b, 128c, 128d are arranged in a generally “G” configuration when decoupled from each other. In some forms, the sections 128a, 128b, 128c, 128d may be arranged in other configurations when decoupled from each other. Each connecting section 128b, 128c, 128d is movable between a stowed position in which the connecting section 128b, 128c, 128d is fixed relative to the main section 128a and a deployed position in which the connecting section 128b, 128c, 128d is movable relative to the main section 128a. The sections 128b, 128c, 128d are located entirely external to the section 128a in the stowed and deployed positions.

In the example illustrated, the sections 128a, 128b, 128c, 128d may be spaced apart from each other once the vehicle component 112 is coupled to the fixture. That is, the sections 128b, 128c, 128d may be moved from the stowed position (the sections 128b, 128c, 128d abut against each other or the section 128a when in the stowed position) to the deployed position once the vehicle component 112 is moved to the fixture such that the sections 128b, 128c, 128d are spaced apart from each other and the section 128a. In the example illustrated, the section 128a of the vehicle component 112 has a length that is greater than a length of the sections 128b, 128c, 128d of the vehicle component 112. In some forms, the section 128a of the vehicle component 112 may have a length that is equal to or less than a length of the sections 128b, 128c, 128d of the vehicle component 112. It should be understood that the electrical components 121 (e.g., wires) extend through the sections 128a, 128b, 128c, 128d of the body 128 and may have ends (e.g., electrical connectors) that are secured to the body 128.

The first collars (not shown) may be coupled to the main section 128a and/or the sections 128b, 128c, 128d. The structure and function of the first collars may be similar or identical to the collars 30a, 30b, 30c described above, and therefore, will not be described again in detail. The second collars 130d may be coupled to the main section 128a and/or the section 128b. The structure and function of the second collars 130d may be similar or identical to the collars 30d described above, and therefore, will not be described again in detail.

The third collars 130e may be coupled to the sections 128c, 128d and may be configured to cooperate with the collars 130d to fixed the sections 128a, 128b, 128c, 128d relative to each other. The third collars 130e may also be configured to support and retain an electrical connector 121a. The structure and function of the third collars 130e may be similar or identical to the collars 30e described above, and therefore, will not be described again in detail.

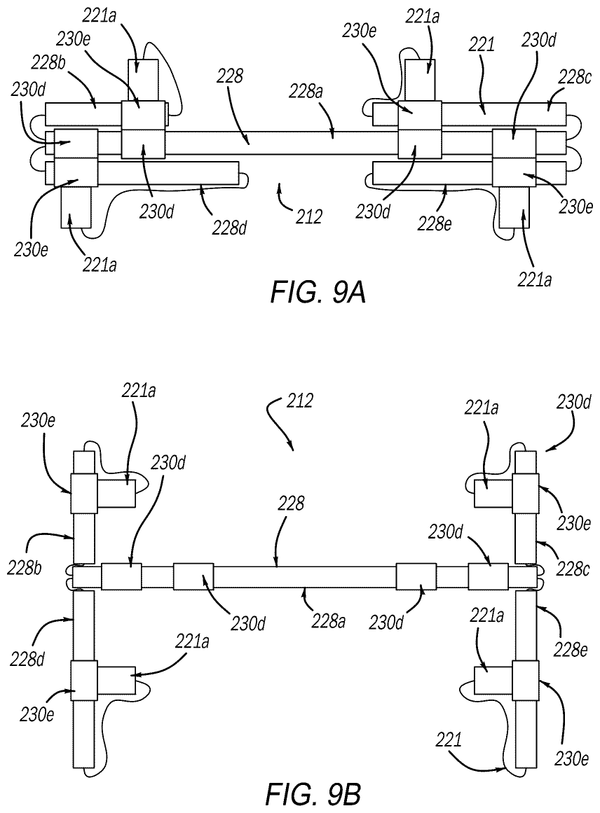

With reference to FIGS. 9A and 9B, another vehicle component 212 is provided. The structure and function of vehicle component 212 is similar or identical to the vehicle component 12 described above, apart from any exception noted below.

The vehicle component 212 includes a body or housing 228, a plurality of collars first collars (not shown), a plurality of second collars 230d, and a plurality of third collars 230e. The body 228 may be made of a rigid material (e.g., metal or plastic) and may house electrical components 221 (e.g., flexible wires). In the example illustrated, the body 228 includes multiple sections 228a, 228b, 228c, 228d, 228e that are movable relative to each other. For example, the section 228a may be the main section and the sections 228b, 228c, 228d, 228e may be connecting sections. The sections 228a, 228b, 228c, 228d, 228e may be coupled to each other (e.g., folding onto each other) as the vehicle component 212 moves from the part support (not shown) to the fixture (not shown). Once the vehicle component 212 is coupled to the fixture, the sections 228a, 228b, 228c, 228d, 228e of the vehicle component 212 may be decoupled from each other (e.g., unfolded from each other) using the robot (not shown) and positioned at predetermined positions with respect to each other for further processing. In the example illustrated, the sections 228b, 228c, 228d, 228e are folded or stacked onto the section 228a. That is, the sections 228b and 228c are folded onto an upper side of the section 228a at or near respective ends of the section 228a and the sections 228d, 228e are folded onto a lower side at or near respective ends of the section 228a.

In the example illustrated, the sections 228b, 228c, 228d, 228e of the vehicle component 212 are decoupled or detached from the section 228a and positioned with respect to the section 228a once the vehicle component 212 is coupled to the fixture. As shown in FIG. 9B, the sections 228a, 228b, 228c, 228d, 228e are arranged in a generally “H” configuration when decoupled from each other. In some forms, the sections 228a, 228b, 228c, 228d, 228e may be arranged in other configurations when decoupled from each other. Each connecting section 228b, 228c, 228d, 228e is movable between a stowed position in which the connecting section 228b, 228c, 228d, 228e is fixed relative to the main section 228a and a deployed position in which the connecting section 228b, 228c, 228d, 228e is movable relative to the main section 228a. The sections 228b, 228c, 228d, 228e are located entirely external to the section 228a in the stowed and deployed positions.

In the example illustrated, the sections 228a, 228b, 228c, 228d, 228e may be spaced apart from each other once the vehicle component 212 is coupled to the fixture. That is, the sections 228b, 228c, 228d, 228e may be moved from the stowed position (the sections 228b, 228c, 228d, 228e abut against each other or the section 228a when in the stowed position) to the deployed position once the vehicle component 212 is moved to the fixture such that the sections 228b, 228c, 228d, 228e are spaced apart from each other and the section 228a. In the example illustrated, the section 228a of the vehicle component 212 has a length that is greater than a length of the sections 228b, 228c, 228d, 228e of the vehicle component 212. In some forms, the section 228a of the vehicle component 212 may have a length that is equal to or less than a length of the sections 228b, 228c, 228d, 228e of the vehicle component 212. As shown in the figures, one or more of the sections 228b, 228c, 228d, 228e have different lengths from the other sections.

The first collars (not shown) may be coupled to the main section 228a and/or the sections 228b, 228c, 228d, 228e. The structure and function of the first collars may be similar or identical to the collars 30a, 30b, 30c described above, and therefore, will not be described again in detail. The second collars 230d may be coupled to the main section 228a. The structure and function of the second collars 230d may be similar or identical to the collars 30d described above, and therefore, will not be described again in detail.

The third collars 230e may be coupled to the sections 228b, 228c, 228d, 228e and may be configured to cooperate with the collars 230d to fixed the sections 228a, 228b, 228c, 228d, 228e relative to each other. The third collars 230e may also be configured to support and retain an electrical connector 221a. The structure and function of the third collars 230e may be similar or identical to the collars 30e described above, and therefore, will not be described again in detail.

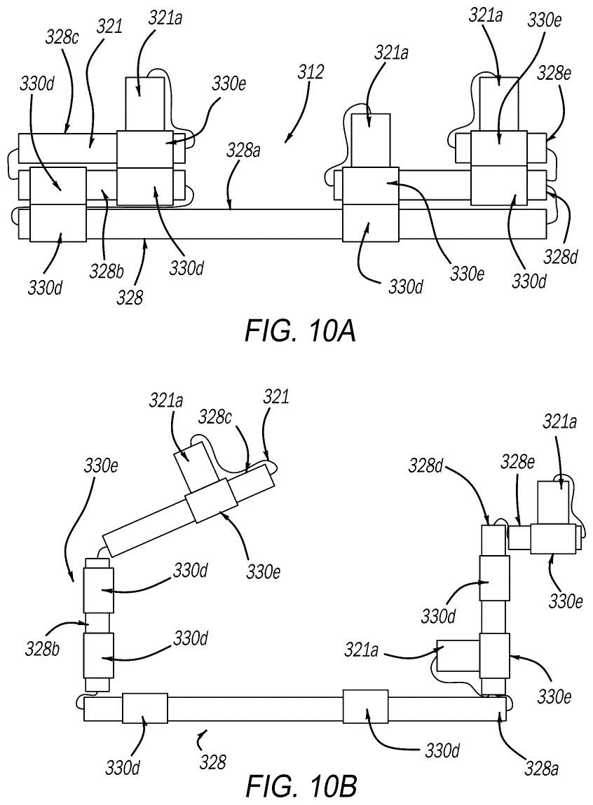

With reference to FIGS. 10A and 10B, another vehicle component 312 is provided. The structure and function of vehicle component 312 is similar or identical to the vehicle component 12 described above, apart from any exception noted below.

The vehicle component 312 includes a body or housing 328, a plurality of collars first collars (not shown), a plurality of second collars 330d, and a plurality of third collars 330e. The body 328 may be made of a rigid material (e.g., metal or plastic) and may house electrical components 321 (e.g., flexible wires). In the example illustrated, the body 328 includes multiple sections 328a, 328b, 328c, 328d, 328e that are movable relative to each other. For example, the section 328a may be the main section and the sections 328b, 328c, 328d, 328e may be connecting sections. The sections 328a, 328b, 328c, 328d, 328e may be coupled to each other (e.g., folding onto each other) as the vehicle component 312 moves from the part support (not shown) to the fixture (not shown). Once the vehicle component 312 is coupled to the fixture, the sections 328a, 328b, 328c, 328d, 328e of the vehicle component 312 may be decoupled from each other (e.g., unfolded from each other) using the robot (not shown) and positioned at predetermined positions with respect to each other for further processing. In the example illustrated, the sections 328b, 328c, 328d, 328e are folded or stacked onto the section 328a. That is, the sections 328b and 328c are folded onto an upper side of the section 328a at one end of the section 328a and the sections 328d, 328e are folded onto the upper side of the section 328a at another opposing end of the section 328a.

In the example illustrated, the sections 328b, 328c, 328d, 328e of the vehicle component 312 are decoupled or detached from the section 328a and positioned with respect to the section 328a once the vehicle component 312 is coupled to the fixture. Each connecting section 328b, 328c, 328d, 328e is movable between a stowed position in which the connecting section 328b, 328c, 328d, 328e is fixed relative to the main section 328a and a deployed position in which the connecting section 328b, 328c, 328d, 328e is movable relative to the main section 328a. The sections 328b, 328c, 328d, 328e are located entirely external to the section 328a in the stowed and deployed positions.

In the example illustrated, the sections 328a, 328b, 328c, 328d, 328e may be spaced apart from each other once the vehicle component 312 is coupled to the fixture. That is, the sections 328b, 328c, 328d, 328e may be moved from the stowed position (the sections 328b, 328c, 328d, 328e abut against each other or the section 328a when in the stowed position) to the deployed position once the vehicle component 312 is moved to the fixture such that the sections 328b, 328c, 328d, 328e are spaced apart from each other and the section 328a. In the example illustrated, the section 328a of the vehicle component 312 has a length that is greater than a length of the sections 328b, 328c, 328d, 328e of the vehicle component 312. In some forms, the section 328a of the vehicle component 312 may have a length that is equal to or less than a length of the sections 328b, 328c, 328d, 328e of the vehicle component 312. As shown in the figures, one or more of the sections 328b, 328c, 328d, 328e have different lengths from the other sections.

The first collars (not shown) may be coupled to the main section 328a and/or the sections 328b, 328c, 328d, 328e. The structure and function of the first collars may be similar or identical to the collars 30a, 30b, 30c described above, and therefore, will not be described again in detail. The second collars 330d may be coupled to one or more of the sections 328a, 328b, 328d. The structure and function of the second collars 330d may be similar or identical to the collars 30d described above, and therefore, will not be described again in detail.

The third collars 330e may be coupled to the sections 328c, 328d, 328e and may be configured to cooperate with the collars 330d to fixed the sections 328a, 328b, 328c, 328d, 328e relative to each other. The third collars 330e may also be configured to support and retain an electrical connector 321a. The structure and function of the third collars 330e may be similar or identical to the collars 30e described above, and therefore, will not be described again in detail.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A wire harness for a vehicle, the wire harness comprising:
a body configured to house electrical components of the vehicle and including a main section and a first connecting section, the first connecting section movable between a stowed position in which the first connecting section is fixed relative to the main section and a deployed position in which the first connecting section is movable relative to the main section; and
a retention structure including a first retention socket coupled to one of the main section and the first connecting section and a first retention feature coupled to the other of the main section and the first connecting section, wherein the first retention feature is received in the first retention socket when the first connecting section is in the stowed position to fix the first connecting section relative to the main section and is removed from the first retention socket when the first connecting section is in the deployed position such that the first connecting section is movable relative to the main section,
wherein the body includes a second retention feature adapted to support one electrical connector of the electrical components.

2. The wire harness of claim 1, wherein the main section and the first connecting section are made of a rigid material.

3. The wire harness of claim 1, wherein when the first connecting section is in the stowed position, the first connecting section abuts against the main section, and when the first connecting section is in the deployed position, the first connecting section is spaced apart from the main section.

4. The wire harness of claim 1, wherein the main section has a length that is greater than a length of the first connecting section.

5. The wire harness of claim 1, wherein when the first connecting section is in the stowed position, the first connecting section extends in the same direction as the main section and is stacked onto the main section.

6. The wire harness of claim 1, further comprising a second connecting section movable between a stowed position in which the second connecting section is fixed relative to the main section and a deployed position in which the second connecting section is movable relative to the main section.

7. The wire harness of claim 6, wherein the first connecting section and the second connecting section are located at opposing ends of the main section.

8. The wire harness of claim 6, wherein the first connecting section and the second connecting section are located at the same end of the main section.

9. The wire harness of claim 6, wherein the first connecting section and the second connecting section are movable between the stowed positions and the deployed positions independently of each other.

10. The wire harness of claim 1, further comprising the electrical components, a first end of one electrical component of the electrical components secured to the main section and a second opposing end of the one electrical component secured to the first connecting section.

11. The wire harness of claim 1, further comprising:
a first collar surrounding and coupled to the first connecting section, the first collar including the first retention feature of the retention structure and the second retention feature; and
the one electrical connector removably coupled to the second retention feature.

12. The wire harness of claim 11, further comprising a second collar surrounding and coupled to the main section, the second collar including an attachment feature configured to couple the body to the vehicle.

13. The wire harness of claim 1, wherein the first connecting section is located entirely external to a cavity of the main section when in the stowed position.

14. A wire harness for a vehicle, the wire harness comprising:
a body configured to house electrical components of the vehicle and including a main section and a plurality of connecting sections, each connecting section movable between a stowed position in which the connecting section is fixed relative to the main section and a deployed position in which the connecting section is movable relative to the main section; and
a plurality of retention structures, each retention structure including a first retention socket coupled to one of the main section and a respective connecting section and a first retention feature coupled to the other of the main section and the respective connecting section, wherein the first retention feature is received in the first retention socket when the respective connecting section is in the stowed position to fix the respective connecting section relative to the main section and is removed from the first retention socket when the respective connecting section is in the deployed position such that the respective connecting section is movable relative to the main section,
wherein the body includes a second retention feature adapted to support at least one electrical connector of the electrical components.

15. The wire harness of claim 14, wherein the main section and the plurality of connecting sections are made of a rigid material.

16. The wire harness of claim 14, wherein when the respective connecting section is in the stowed position, the respective connecting section abuts against the main section, and when the respective connecting section is in the deployed position, the respective connecting section is spaced apart from the main section.

17. The wire harness of claim 14, wherein the main section has a length that is greater than a length of the respective connecting section.

18. The wire harness of claim 14, wherein when the respective connecting section is in the stowed position, the respective connecting section extends in the same direction as the main section and is stacked onto the main section.

19. The wire harness of claim 14, wherein the plurality of connecting sections are movable between the stowed positions and the deployed positions independently of each other.

20. A wire harness for a vehicle, the wire harness comprising:
a plurality of electrical components;
a body housing the plurality of electrical components and including a main section and a plurality of connecting sections, each connecting section movable between a stowed position in which the connecting section is fixed relative to the main section and a deployed position in which the connecting section is movable relative to the main section; and
a plurality of retention structures, each retention structure including a first retention socket coupled to one of the main section and a respective connecting section and a retention feature coupled to the other of the main section and the respective connecting section, wherein the retention feature is received in the first retention socket when the respective connecting section is in the stowed position to fix the respective connecting section relative to the main section and is removed from the first retention socket when the respective connecting section is in the deployed position such that the respective connecting section is movable relative to the main section,
wherein a first end of one electrical component of the plurality of electrical components coupled to the main section and a second opposing end of the one electrical component coupled to a respective connecting section of the plurality of the connecting sections.
